(19) United States
(12) Patent Application Publication
(10) Pub. No.: US 2010/0270098 A1
(43) Pub. Date: Oct. 28, 2010

(54) MOTORCYCLE WITH MOVABLE EXHAUST SYSTEM

(75) Inventor: Erik Buell, Mukwonago, WI (US)

Correspondence Address: MICHAEL BEST & FRIEDRICH LLP, 100 E WISCONSIN AVENUE, Suite 3300, MILWAUKEE, WI, 53202, US

(73) Assignee: BUELL MOTORCYCLE COMPANY, East Troy, WI (US)

(21) Appl. No.: 12/429,667

(22) Filed: Apr. 24, 2009

(51) Int. Cl. B60K 13/04; B62K 11/04; F01N 7/08

(52) U.S. Cl. 180/225; 180/296

(57) ABSTRACT

A motorcycle including a swingarm that movably mounts a rear wheel to a main frame of the motorcycle and defines a hollow portion through which exhaust gases are passed before being expelled from an outlet of the swingarm. A movable joint may be provided between a header and the swingarm, including a first portion fixed relative to the main frame, a second portion movable relative to the main frame, and a flexible conduit between the first and second portions. The movable joint may be coincident with the pivot axis. In some constructions, the hollow portion of the swingarm is divided into at least three chambers, and a plurality of pipes is configured to provide at least two flow direction reversals within the swingarm between an inlet and an outlet, with multiple volumetric expansions between the inlet and the outlet.

### BACKGROUND

The present invention relates to motorcycles, and particularly to the configuration and positioning of an exhaust system and exhaust system components on a motorcycle.

Like any vehicle with an internal combustion engine, motorcycles produce hot exhaust gases as a result of the combustion process. Exhaust gases typically are routed away from the engine and toward the rear of the motorcycle through an exhaust system including exhaust pipes, catalytic converters, and mufflers.

### SUMMARY

The present invention provides a motorcycle having a main frame, a front wheel mounted for rotation relative to the main frame, a rear wheel mounted for rotation relative to the main frame, an engine coupled to the rear wheel, a header coupled to the engine to direct exhaust gases out of the engine, and a swingarm supporting the rear wheel and mounted for movement relative to the main frame. The swingarm includes a hollow portion in communication with the header. The swingarm is configured to muffle the noise of exhaust gases. The swingarm has an outlet in communication with the hollow portion through which exhaust gases are expelled.

In another embodiment, the present invention provides a motorcycle swingarm for rotatably mounting a wheel of a motorcycle, the swingarm being movable relative to a main frame of the motorcycle. The swingarm includes a forward portion including a mounting portion configured to define a pivot axis and a rearward portion configured to receive an axle for rotatably mounting the rear wheel. An inlet of the swingarm is configured to receive exhaust gases from an engine of the motorcycle, and an outlet of the swingarm is configured to expel exhaust gases from the swingarm. A hollow portion extends between the inlet and the outlet defining a flow path between the inlet and the outlet. The flow path is configured to provide a sound muffling effect.

Other aspects of the invention will become apparent by consideration of the detailed description and accompanying drawings. Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### BRIEF DESCRIPTION OF THE DRAWINGS

FIG. 1 is a side view of a motorcycle embodying various aspects of the present invention;

FIG. 2 is an enlarged section view of the exhaust system of the motorcycle of FIG. 1;

FIG. 3A is a perspective view of a modified swingarm pivot arrangement;

FIG. 3B is a perspective view of another modified swingarm pivot arrangement;

FIG. 4 is an enlarged section view of an alternate swingarm and exhaust system for the motorcycle of FIG. 1;

FIG. 5 is another enlarged section view of the exhaust system of FIG. 4.

FIG. 6 is a perspective view of a modified swingarm similar to that of FIGS. 4 and 5; and

FIG. 7 is a perspective view of another modified swingarm similar to that of FIGS. 4 and 5.

### DETAILED DESCRIPTION

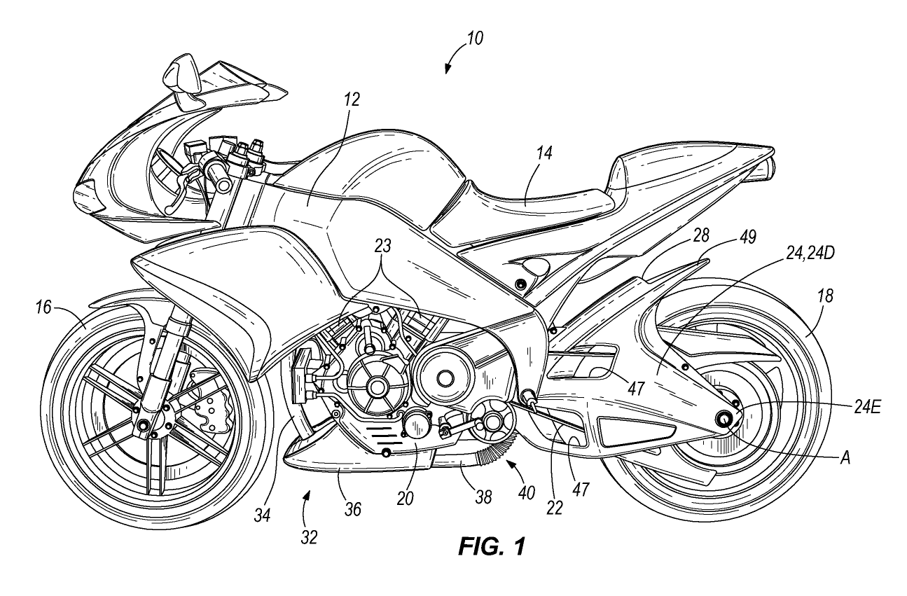

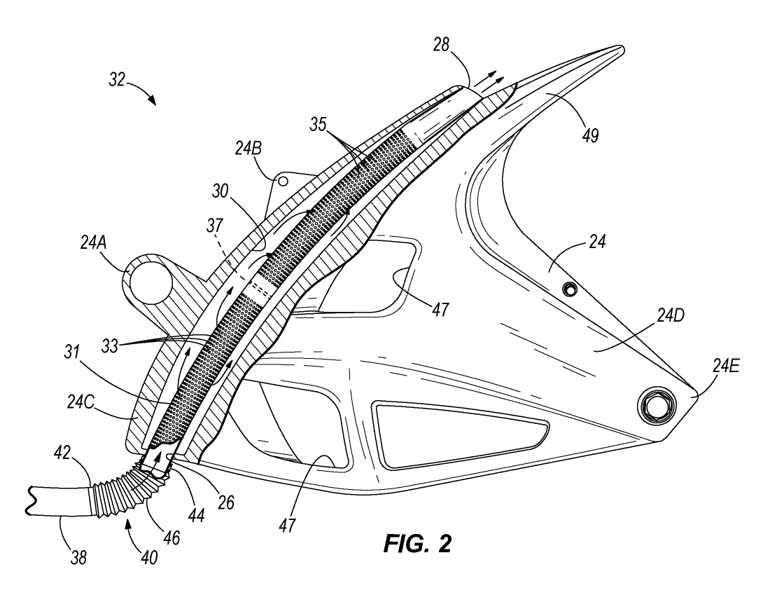

The motorcycle 10 illustrated in FIGS. 1 and 2 includes a main frame 12, a seat 14, a front wheel 16, a rear wheel 18, and an engine/transmission assembly 20. The engine/transmission assembly 20 is coupled to and provides power to the rear wheel 18 through a drive member (e.g., drive belt 22). The engine/transmission assembly 20 includes two cylinders 23 for combusting an air-fuel mixture.

The illustrated motorcycle 10 further includes a swingarm 24 that rotatably supports the rear wheel 18. The swingarm 24 is movably mounted relative to the main frame 12. In the illustrated construction, the swingarm 24 is pivotally coupled to the transmission, which is coupled to the main frame 12 to be substantially fixed relative thereto, via a swingarm mounting boss 24A that receives a pivot shaft (not shown). In alternate constructions, the swingarm 24 can be pivotally coupled to an integral part of the engine/transmission assembly 20 or the main frame 12, or a separate part (e.g., a suspension link) coupled to either of the engine/transmission assembly 20 or the main frame 12. A pair of suspension mounting flanges 24B couple a rear suspension (not shown) between the swingarm 24 and the main frame 12 (or another structure fixed thereto) to provide resilient support and shock absorption for the rear of the motorcycle 10. The swingarm mounting boss 24A is positioned on a forward portion 24C of the swingarm 24. A pair of fork portions 24D extend rearward from the forward portion 24C and provide mounting locations for a rear axle A (FIG. 1), which supports the rear wheel 18, at a rearward portion 24E of the swingarm 24. The swingarm includes a swingarm inlet 26, a swingarm outlet 28, and a hollow portion 30 connecting the inlet 26 and the outlet 28.

A perforated pipe 31 is positioned between the inlet 26 and the outlet 28 to provide sound deadening. The pipe 31 includes a series of outlet perforations 33 and a series of inlet perforations 35. A baffle 37 is mounted inside the pipe 31 between the outlet and inlet perforations 33, 35. The hollow portion 30 provides a muffling volume, which can be as large as the swingarm 24 will accommodate. While the illustrated hollow portion 28 is substantially free of sound-deadening materials, it should be understood that baffles, batting, and/or other sound-deadening materials may be positioned inside the hollow portion 30 in order to further silence the sound of the engine. When the volume of the hollow portion 30 within the swingarm 24 is made sufficiently large and/or provided with sufficient sound deadening structures/materials, the motorcycle 10 does not need any muffler other than the muffler provided by the swingarm 24.

The swingarm 24 forms one portion of an exhaust system 32 of the motorcycle 10 that is coupled to the engine/transmission assembly 20 and positioned to direct exhaust gases away from the engine/transmission assembly 20. The illustrated exhaust system 32 includes a header 34 coupled to the engine/transmission assembly 20, a first-stage muffler 36 coupled to the header 34, an intermediate pipe 38 coupled to the muffler 36, and a movable joint 40 coupled to the intermediate pipe 38 and defining a movable pathway communicating with the hollow portion 30 of the swingarm 24. As noted above, the first-stage muffler 36 can be eliminated when the muffling characteristics of the swingarm 24 are sufficient.

The movable joint 40 illustrated in FIG. 2 includes a first portion 42 fixed relative to the engine/transmission assembly 20, and a second portion 44 fixed relative to the swingarm 24. The first portion 42 is coupled to the intermediate pipe 38, and the second portion 44 communicates with the swingarm inlet 26 and the hollow portion 30 of the swingarm 24. Because the swingarm 24 is mounted for pivotal movement relative to the engine/transmission assembly 20, the second portion 44 of the movable joint 40 is pivotable relative to the first portion 42 of the movable joint 40. The first portion 42 and the second portion 44 are connected by a flexible conduit in the form of a flexible metallic bellows 46. The bellows 46 allows fluid communication between the intermediate pipe 38 and the swingarm inlet 26 to be maintained when the swingarm 24 pivots about an axis defined by the mounting boss 24A, which is spaced from the swingarm inlet 26. It should be understood that other types of flexible joints can be used to practice the present invention.

The swingarm 24 includes openings 47 through a sidewall of the swingarm 24. The openings 47 allow a drive member (e.g., drive belt 22) to extend through the swingarm 24 to drive the rear wheel 18 and further provide pathways for ambient air to pass, which is designed to provide a cooling effect to the swingarm 24. The swingarm 24 also includes a fender portion 49 adjacent the swingarm outlet 28. The fender portion 49 acts as a fender, thus alleviating the need for a separate fender.

In operation, exhaust gases exiting the engine/transmission assembly 20 pass through the headers 34 and into the muffler 36. The exhaust gases then exit the muffler 36, pass through the intermediate pipe 38, and enter the flexible bellows 46. The exhaust gases then enter the swingarm inlet 26 and flow into the pipe 31. The baffle 37 forces the gas through the outlet perforations 33 and into the hollow portion 30 of the swingarm 24. The gas will then be forced through the inlet perforations 35 back into the pipe 31 and through the swingarm outlet 28. In this manner, the exhaust gases pass through at least a portion of the swingarm 24 and the exhaust sound is muffled by the swingarm 28. Due to the positioning and orientation of the swingarm outlet 28, the exhaust gases are directed upward and away from the tire on the rear wheel 18 of the motorcycle 10.

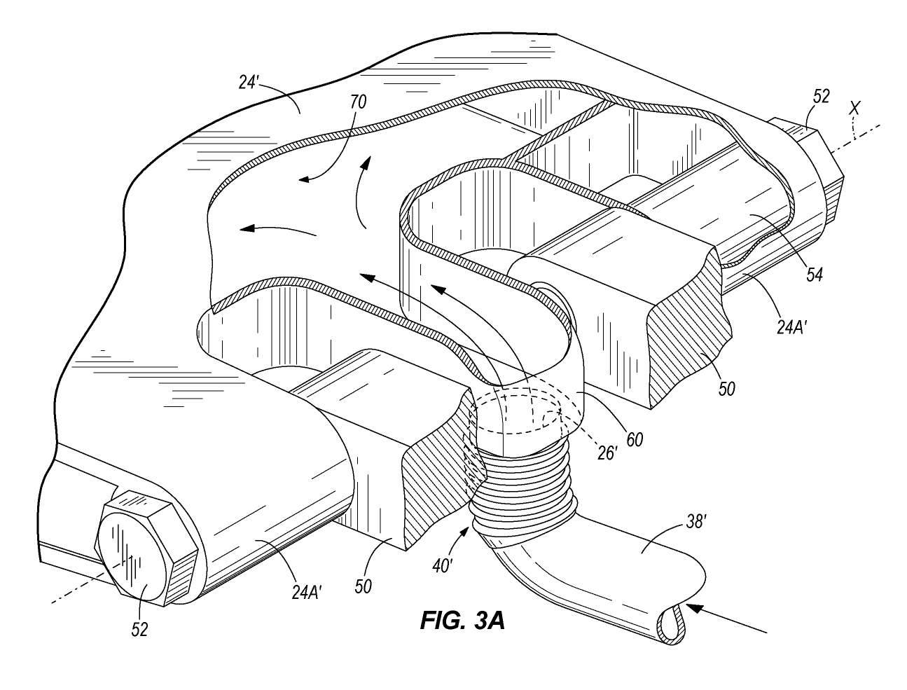

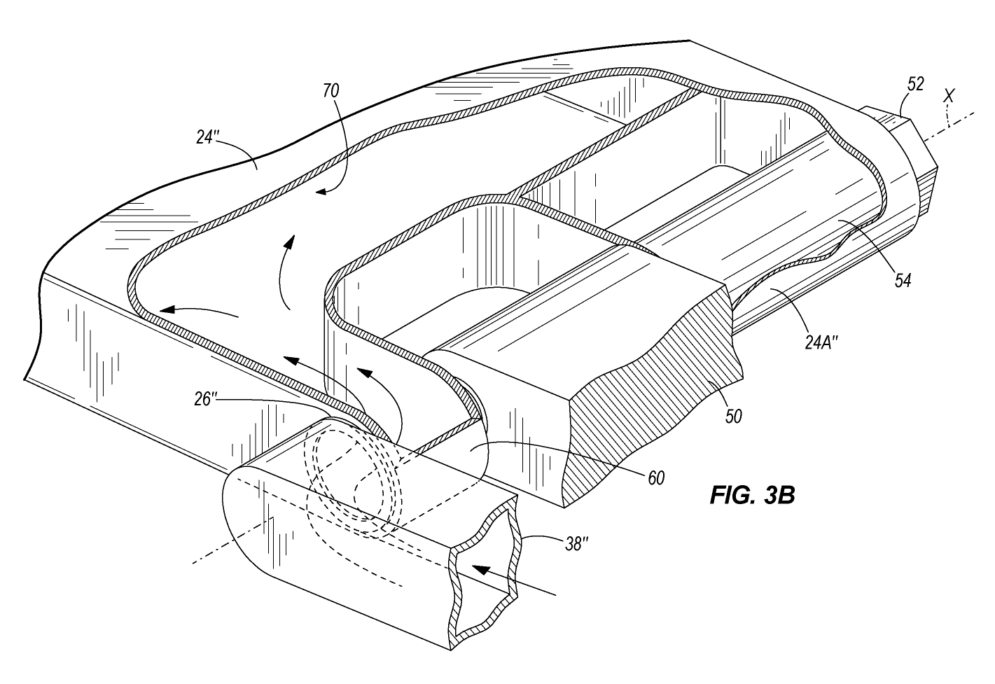

FIG. 3A illustrates a modified swingarm 24′, swingarm mounting arrangement, and exhaust passage in which the pivot location of the swingarm 24′ is substantially coincident with the location at which exhaust gases are directed into the swingarm 24′. The alternate structure of FIG. 3A can be implemented with the motorcycle 10 and the exhaust system 32 illustrated in FIG. 1 such that exhaust gases are directed from the engine heads to the muffler 36 by headers 34 before being further directed to the swingarm 24′ by an intermediate pipe 38′ and a movable joint 40′ that couples the intermediate pipe 38′ to the swingarm 24′.

A pair of mounting bosses 24A′ of the swingarm 24′ are pivotably mounted relative to the main frame 12. In the illustrated construction, the mounting bosses 24A′ are joined with the two respective halves of a forked pivot housing 50 with separate pivot shafts 52, which jointly define a pivot axis X. The pivot housing 50 can be an integral part of the engine/transmission assembly 20 or the main frame 12, or can be a separate part (e.g., a suspension link) coupled to either of the engine/transmission assembly 20 or the main frame 12. A bearing 54 at each of the pivot shafts 52 pivotally supports the swingarm 24′ relative to the pivot housing 50.

A gas inlet 26′ is formed in a tongue portion 60 of the swingarm 24′ to receive exhaust gases into the interior of the swingarm 24′. The tongue portion 60 is shaped similarly to the two mounting bosses 24A′ and is positioned therebetween. The tongue portion 60 is positioned generally at a central location along the pivot axis X, between the two halves of the forked pivot housing 50. Although the forked pivot housing 50 and the mounting bosses 24A′ are illustrated to be left-right symmetrical, they can be modified in alternate constructions to be asymmetrical, and the tongue portion 60 may or may not be centrally located along the pivot axis X. The gas inlet 26′ is in communication with a hollow portion 70 of the swingarm 24′ through the tongue portion 60, which itself is hollow, so that exhaust gases can enter the interior of the swingarm 24′. The exhaust gases can then exit the swingarm 24′ through the swingarm outlet (not shown in FIG. 3A). The hollow portion 70 may or may not include baffles, batting, and/or other sound-deadening material in order to further silence the sound of the engine. When the volume of the hollow portion 70 within the swingarm 24′ is made sufficiently large and/or provided with sufficient sound deadening structures/materials, the motorcycle 10 does not need any muffler other than the muffler provided by the swingarm 24′.

In operation, exhaust gases from the engine pass through the header pipe, through the muffler 36, and through the intermediate pipe 48. The exhaust gases then enter the hollow portion 70 of the swingarm 24′ through the movable joint 40′ and the gas inlet 26′ at a location substantially coincident with the pivot axis X of the swingarm 24′. The gas inlet 26′ directs exhaust gas entry in a direction substantially perpendicular to the pivot axis X. The hollow portion 70 of the swingarm 24′ guides the exhaust gases to the swingarm outlet where the exhaust gases exit to the atmosphere. The exhaust system and swingarm pivot construction illustrated in FIG. 3A brings the pivot axis X and the movable joint 40′ close together while isolating the bearings 54 from the heat of the exhaust gases. Bringing the pivot axis X and the movable joint 40′ close together reduces the amount of flexibility or extension/contraction required of the movable joint 40′ as the swingarm 24′ operates.

FIG. 3B illustrates another modified swingarm 24″, swingarm mounting arrangement, and exhaust passage in which the pivot location of the swingarm 24″ is substantially coincident with the location at which exhaust gases are directed into the swingarm 24″. The alternate structure of FIG. 3B can be implemented with the motorcycle 10 and the exhaust system 32 illustrated in FIG. 1 such that exhaust gases are directed from the engine heads to the muffler 36 by headers 34 before being further directed to the swingarm 24″ by an intermediate pipe 38′ that is coupled directly to the swingarm 24′. The structure of FIG. 3B is substantially identical to that of FIG. 3A with the exception of the differences specifically pointed out below. Thus, common reference numbers are used to refer to common parts.

The swingarm 24″ includes a single mounting boss 24A″ that is substantially wider than either of the mounting bosses 24A′ of FIG. 3A. Furthermore, the pivot housing 50 to which the mounting portion 24A″ is coupled is also singular and wider than its counterpart of FIG. 3A. Thus, a single pivot shaft 52 is used to mount the swingarm 24″.

The intermediate pipe 38″ extends alongside the tongue portion 60 of the swingarm 24″ and directs exhaust gases through a gas inlet 26″ into the tongue portion 60. Contrary to the gas inlet 26′ of FIG. 3A, the gas inlet 26″ of FIG. 3B directs exhaust gas entry into the tongue portion 60 in a direction substantially parallel with and coaxial with the pivot axis X. A rotatable seal (e.g., a graphite seal or other high temperature seal) is formed at the gas inlet 26″ so that the intermediate pipe 38″ can remain fixed with respect to the main frame 12 while the swingarm 24″ pivots to accommodate road bumps and such.

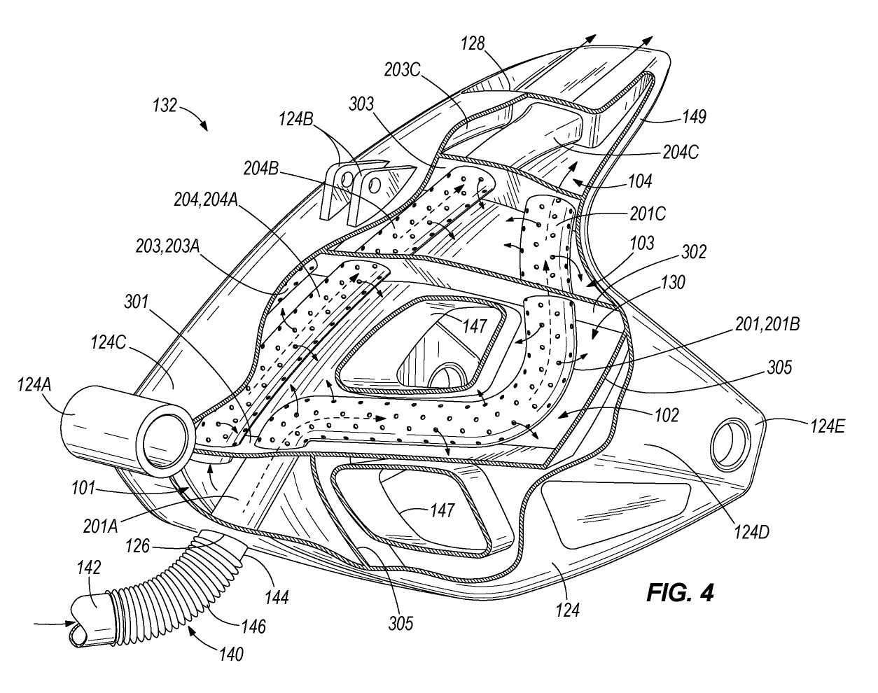

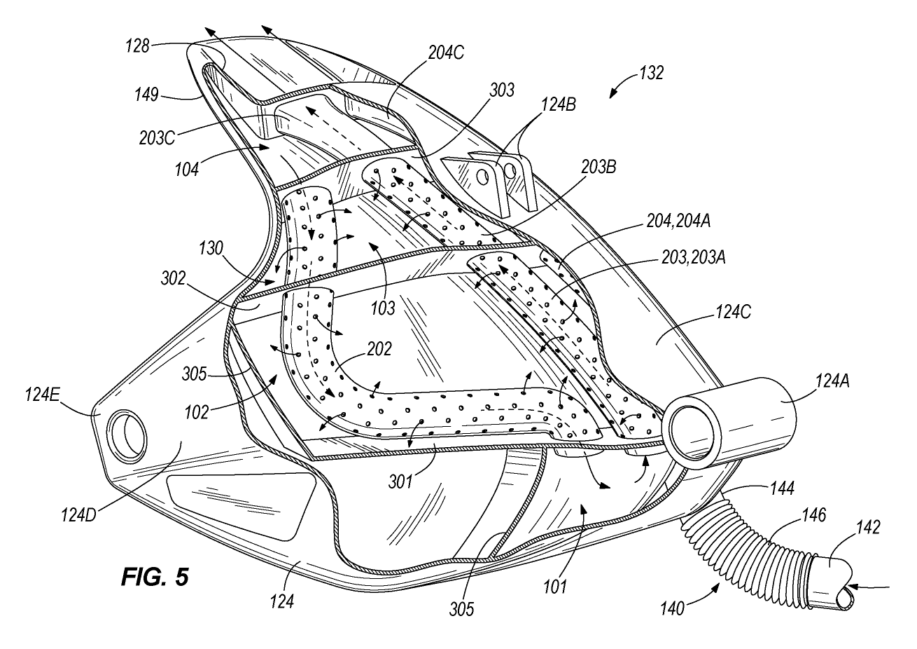

FIGS. 4 and 5 illustrate an alternate swingarm 124 that can replace the swingarm 24 of the illustrated exhaust system 32 to provide the motorcycle 10 with an alternate exhaust system 132 (only a rear portion of which is shown in FIGS. 4 and 5). The swingarm 124 is similar to the swingarm 24 of FIGS. 1 and 2, but is designed to provide an alternate flow configuration and correspondingly alternate sound muffling performance and alternate engine performance. A movable joint 140 of the exhaust system 132 is similar to the movable joint 40 illustrated in FIGS. 1 and 2. The swingarm 124 of FIGS. 4 and 5 is similar to the swingarm 24 of FIGS. 1 and 2, with the exception of the features described in detail below. Like parts have been given similar reference numbers in the 100 series.

As shown in FIGS. 4 and 5, the swingarm 124 includes an inlet 126 and an outlet 128 and defines a “tri-flow” configuration in which there are two flow direction reversals between the inlet 126 and the outlet 128. The flow of exhaust gases makes three “passes” within the swingarm 124. Additional passes and flow reversals may be provided. Exhaust gases flow from the inlet 126 in the direction of (but not out of) the outlet 128 before being routed back in the direction of the inlet 126 (along a separate path) and finally a second time toward (and out of) the outlet 128. Inside the swingarm 124, the hollow space 130 is divided into chambers 101-104 interconnected by a plurality of pipes 201-204 as described in detail below. The chambers 101-104 are separated by three bulkheads 301-303, and additional walls 305 within the swingarm 124 are optionally provided to limit the size of the hollow space 130 relative to the overall size of the swingarm 124. Portions of the pipes 201-204 are perforated to allow exhaust gas communication back and forth between the interior of the pipes 201-204 and the chambers 101-104 through which the perforated portions extend. Exhaust gas noise is reduced by volumetric expansion as exhaust gases are able to expand through the perforations of each of the respective pipes 201-204.

Exhaust gases flow from the inlet 126 into the first pipe 201, which has a first section 201A within the first chamber 101 as shown in FIG. 4. The first section 201A of the first pipe 201 is not perforated such that exhaust gases routed through the first section 201A do not flow into the first chamber 101. Second and third sections 201B, 201C of the first pipe 201 extend through the second and third chambers 102, 103 respectively. Both the second and third sections 201B, 201C of the first pipe 201 are perforated so that a portion of the exhaust gases flowing through the first pipe 201 escapes into the second and third chambers 102, 103 as shown by the arrows in FIG. 4. The first pipe 201 discharges into the fourth chamber 104, which is adjacent the fender portion 149 and adjacent (but not in direct communication with) the swingarm outlet 128.

From the fourth chamber 104, exhaust gases flow into the second pipe 202 (FIG. 5). Similar to the second and third sections 201B, 201C of the first pipe 201, the second pipe 202 extends between the first and third bulkheads 301, 303 and is perforated to allow a portion of the exhaust gases flowing therein to escape into the second and third chambers 102, 103 as shown by the arrows. The second pipe 202 ultimately discharges into the first chamber 101.

The third and fourth pipes 203, 204 both receive exhaust gases from the first chamber 101. The third and fourth pipes 203, 204 both route exhaust gases from the first chamber 101 to the swingarm outlet 128. Respective first and second sections 203A, 203B, 204A, 204B extend between the first and third bulkheads 301, 303 and are perforated to allow a portion of the exhaust gases therein to escape to the second and third chambers 102, 103. Respective third portions 203C, 204C of the third and fourth pipes 203, 204 are not perforated and are configured to direct exhaust gases within the third and fourth pipes 203, 204 to the swingarm outlet 128 without flowing into the fourth chamber 104. The swingarm outlet 128 may be configured as a combined or joint outlet for the third and fourth pipes 203, 204 or as two separate and parallel outlets to discharge exhaust gases from the swingarm 124. In alternate constructions, only a single pipe may be provided to direct the flow of exhaust gases from the first chamber 101 to the outlet 128.

The second and third chambers 102, 103 function as noise cancellation chambers by allowing expansion and also interaction (mixing, wave cancellation, etc.) between multiple flows of exhaust gases. Although described in context above as allowing the escape of exhaust gases, the perforated portions of each pipe 201-204 also allow previously-escaped exhaust gases from all pipes 201-204 to be received back into the pipes 201-204 from the second and third chambers 102, 103. This creates many different possible paths for exhaust gases to flow from the inlet 126 to the outlet 128, allowing a great deal of mixing and noise cancellation. It should also be noted that, while the drawings illustrate two mixing chambers 102, 103, one, three or more separate chambers may be defined within the hollow space 130 to be in communication with the perforated sections of the pipes 201-204. The first and fourth chambers 101, 104 provide volumetric expansion and change of flow direction, but no mixing between separate flows of exhaust gases.

Similar to the swingarm 24 of FIGS. 1 and 2, the swingarm 124 includes a boss 124A for pivotally mounting the swingarm 124, a pair of mounting flanges 124B for coupling a rear suspension, and a fender portion 149 that extends at least partially over the upper portion of the rear wheel 18. The chambers 101-104 and the pipes 201-204 may be alternately configured within the hollow space 130 of the swingarm 124 to optimize certain characteristics, such as overall noise reduction, engine performance, operability with different engines, and swingarm size and shape, among others. For example, the length of one or more of the pipes 201-204 may be increased or decreased and/or the volume of one or more of the chambers 101-104 may be increased or decreased from that which is illustrated in FIGS. 4 and 5. In any configuration, the swingarm 124 provides a single means for both pivotably supporting the rear wheel 18 relative to the main frame 12 of the motorcycle 10 and reducing the noise emitted by the engine.

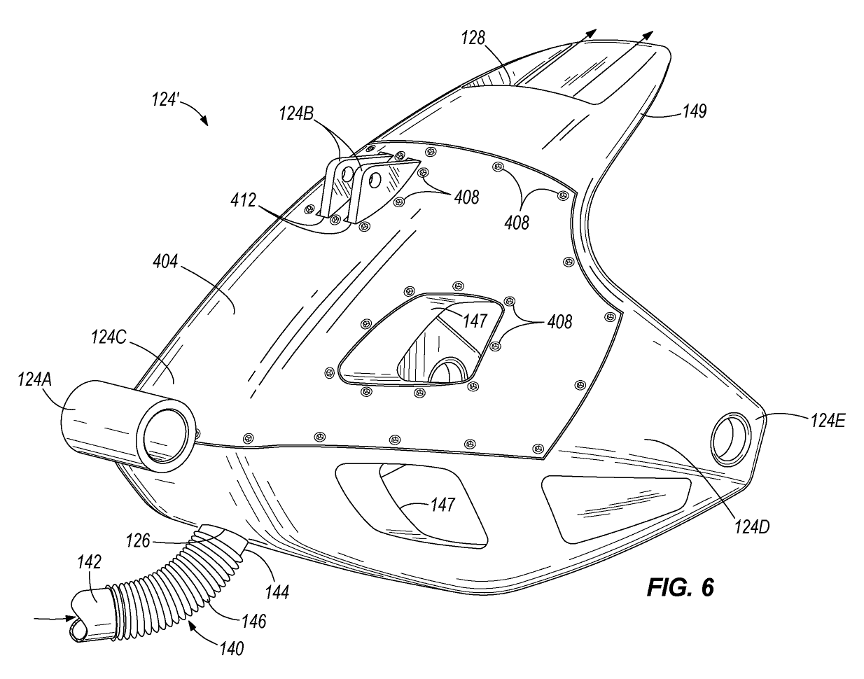

FIG. 6 illustrates a modified swingarm 124′ similar to the swingarm 124 of FIGS. 4 and 5. Common parts are labeled with common reference numbers where applicable. The swingarm 124′ of FIG. 6 varies with respect to the swingarm 124 of FIGS. 4 and 5 by including a multi-piece outer shell including a removable portion 404. The removable portion 404 can be sealingly coupled to the main portion of the swingarm 124′ with a plurality of fasteners 408 and is configured to enclose the hollow portion 130 (shown in FIGS. 4 and 5) of the swingarm 124′. The mounting flanges 124B may be configured to be integrally formed with the main portion of the swingarm 124′ and to extend through apertures 412 in the removable portion 404 such that the removable portion 404 need not be designed to bear suspension loads.

By providing the swingarm 124′ with the removable portion 404, the manufacturability of the interior components of the swingarm 124′ (i.e., the perforated pipes 201-204 and the bulkheads 301-303 and 305) is increased. For example, a casting process used to form the interior components can be simplified. The bulkheads 301-303 and 305 can be utilized as a base structure for receiving the fasteners 408 to couple the removable portion 404 to the main portion of the swingarm 124′. The hollow portion 130 is also made accessible as necessary by way of the removable portion 404.

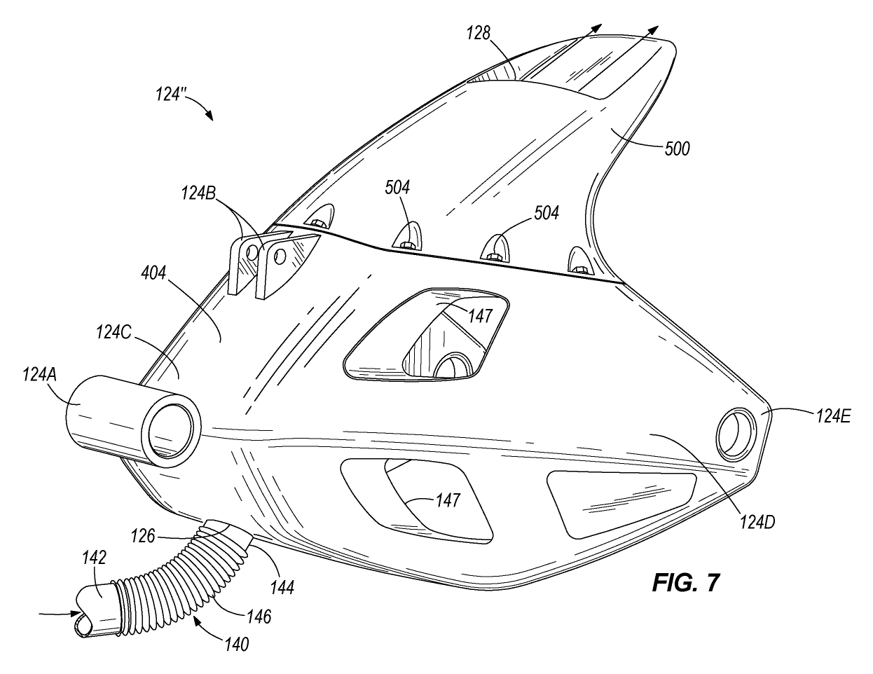

FIG. 7 illustrates a modified swingarm 124″ similar to the swingarm 124 of FIGS. 4 and 5. Common parts are labeled with common reference numbers where applicable. The swingarm 124″ of FIG. 7 varies with respect to the swingarm 124 of FIGS. 4 and 5 by including a fender portion 500 that is constructed of a material different from the material of the main portion of the swingarm 124″. For example, the fender portion 500 may be constructed of a lightweight non-metallic material, such as a high-temperature-withstanding plastic, and the main portion of the swingarm 124″ may be constructed of a lightweight metal, such as aluminum. The bulkhead 302 (FIGS. 4 and 5) may be used as a base structure for coupling the fender portion 500 to the main portion of the swingarm 124″ with a plurality of fasteners 504. The use of a non-metallic fender portion 500 allows the weight of the swingarm 124″ to be reduced as compared to an all-metal swingarm construction. Although exotic lightweight metals can be used in any of the swingarms illustrated herein, constructing the fender portion 500 from a non-metallic material such as plastic allows weight reduction in a very cost efficient manner.

What is claimed is:

1. A motorcycle comprising:
a main frame;
a front wheel mounted for rotation relative to the main frame;
a rear wheel mounted for rotation relative to the main frame;
an engine coupled to the rear wheel;
a header coupled to the engine to direct exhaust gases out of the engine; and
a swingarm supporting the rear wheel and mounted for movement relative to the main frame, wherein the swingarm includes a hollow portion in communication with the header, the swingarm being configured to muffle the noise of exhaust gases, the swingarm having an outlet in communication with the hollow portion through which exhaust gases are expelled.

2. The motorcycle of claim 1, wherein the header is in communication with a movable joint that defines a movable pathway for exhaust gas communication between the header and the hollow portion of the swingarm.

3. The motorcycle of claim 2, further comprising a muffler interposed between the header and the movable joint.

4. The motorcycle of claim 2, wherein the movable joint includes a first portion fixed relative to the main frame, a second portion movable with the swingarm relative to the main frame, and a flexible conduit between the first and second portions.

5. The motorcycle of claim 4, wherein the swingarm is pivotally coupled relative to the main frame about a pivot axis, and wherein the second portion is pivotable with the swingarm about the pivot axis.

6. The motorcycle of claim 4, wherein the flexible conduit includes a flexible bellows.

7. The motorcycle of claim 2, wherein the movable joint is positioned substantially coincident with a pivot axis of the swingarm.

8. The motorcycle of claim 7, wherein the swingarm includes two spaced apart mounting bosses that are pivotally coupled to a pivot housing with separate pivot shafts, and an intermediate portion positioned substantially between the mounting bosses, and wherein the intermediate portion is configured to receive exhaust gases from the movable joint and to direct exhaust gases to the hollow portion of the swingarm.

9. The motorcycle of claim 1, wherein the swingarm includes at least one perforated pipe positioned inside the hollow portion.

10. The motorcycle of claim 9, wherein the hollow portion of the swingarm is divided into a plurality of chambers interconnected by a plurality of pipes, including the at least one perforated pipe.

11. The motorcycle of claim 10, wherein the hollow portion is divided into at least three chambers and the plurality of pipes are configured to provide at least two flow direction reversals between an inlet and an outlet of the swingarm.

12. The motorcycle of claim 11, wherein the hollow portion is divided into four chambers, at least two of which are configured to receive exhaust gases through perforations in multiple ones of the plurality of pipes to allow mixing and noise cancellation therebetween.

13. A motorcycle swingarm for rotatably mounting a wheel of a motorcycle, the swingarm being movable relative to a main frame of the motorcycle, the motorcycle swingarm comprising:
a forward portion including a mounting portion configured to define a pivot axis;
a rearward portion configured to receive an axle for rotatably mounting the rear wheel;
an inlet configured to receive exhaust gases from an engine of the motorcycle;
an outlet configured to expel exhaust gases from the swingarm; and
a hollow portion extending between the inlet and the outlet defining a flow path between the inlet and the outlet, the flow path configured to provide a sound muffling effect.

14. The motorcycle swingarm of claim 13, wherein the exhaust inlet is positioned along the pivot axis.

15. The motorcycle swingarm of claim 14, wherein the exhaust inlet is positioned substantially centrally along the pivot axis.

16. The motorcycle swingarm of claim 13, wherein the mounting portion of the swingarm includes two spaced apart mounting bosses, and the swingarm further includes an intermediate portion positioned substantially between the mounting bosses, and wherein the exhaust inlet is positioned in the intermediate portion.

17. The motorcycle swingarm of claim 13, further comprising a pipe extending through the hollow portion, the pipe having at least a portion that is perforated to communicate exhaust gases back and forth between the interior of the pipe and the hollow portion as exhaust gases flow through the swingarm from the inlet to the outlet

18. The motorcycle swingarm of claim 17, wherein the hollow portion of the swingarm is divided into a plurality of chambers, and the pipe is one of a plurality of pipes interconnecting the plurality of chambers.

19. The motorcycle of claim 18, wherein the hollow portion is divided into at least three chambers and the plurality of pipes are configured to provide at least two flow direction reversals between an inlet and an outlet of the swingarm.

20. The motorcycle of claim 19, wherein the hollow portion is divided into four chambers, at least two of which are configured to receive exhaust gases through perforations in multiple ones of the plurality of pipes to allow mixing and noise cancellation therebetween.
